(19) United States
(12) Patent Application Publication
(10) Pub. No.: US 2014/0085486 A1
(43) Pub. Date: Mar. 27, 2014

(54) INFORMATION PROCESSING TERMINAL, INFORMATION PROCESSING METHOD, AND APPARATUS CONTROL SYSTEM

(71) Applicant: Fujitsu Mobile Communications Limited, Kawasaki-shi (JP)

(72) Inventor: Masafumi Emura, Kiyose (JP)

(21) Appl. No.: 13/931,318

(22) Filed: Jun. 28, 2013

(30) Foreign Application Priority Data
Sep. 26, 2012 (JP) 2012-212371

(51) Int. Cl. H04N 5/232

(52) U.S. Cl. CPC H04N 5/23222
USPC 348/207.1

(57) ABSTRACT

An information processing terminal includes a search unit configured to search for identification information of display apparatus capable of communicating via a network, a sending unit configured to send to the found display apparatus an identification information display request for displaying identification information of the display apparatus, an imaging unit configured to capture an image of the identification information displayed on a display unit of the display apparatus in response to the identification information display request, and an extraction unit configured to extract the identification information from the captured image.

### CROSS-REFERENCE TO RELATED APPLICATION

This application is based upon and claims the benefit of priority of the prior Japanese Patent Application No. 2012-212371, filed on Sep. 26, 2012, the entire contents of which are incorporated herein by reference.

### FIELD

The disclosures herein are generally related to an information processing terminal, an information processing method, and an apparatus control system.

### BACKGROUND

Numerous studies have recently been conducted on a technology that may enable the interconnection of home electronic apparatuses. Specifications for implementing such a technology have been specified in the guidelines defined by the Digital Living Network Alliance (DLNA) (hereinafter referred to as “DLNA guidelines”).

In the DLNA guidelines, electronic apparatuses are classified by a concept of device classes based on functions of the electronic apparatuses. The device classes may include a digital media server (DMS), a digital media renderer (DMR), a digital media controller (DMC).

DMS serves as an electronic apparatus configured to save contents and deliver the contents to DMR and the like connected to a network. DMR serves as an electronic apparatus configured to regenerate the contents. DMC serves as an electronic apparatus configured to search for electronic apparatuses connected to the network and contents saved in the DMS, and send an instruction to regenerate the contents to the DMR.

For example, a user may search for electronic apparatuses connected to a network by utilizing an information processing terminal 10 serving as the DMC, and select a desired one of the electronic apparatuses serving as the DMR configured to regenerate the contents or serving as the DMS configured to transfer the contents to the regenerating destination (i.e., DMR) (hereinafter may also referred to as a “content regenerating destination”) such that that the regenerating destination may be able to regenerate the contents. As a result, the contents saved in the DMS, may, for example, be displayed on a television serving as the DMR.

### RELATED ART DOCUMENTS

Patent Document 1: Japanese Laid-open Patent Publication No. 2009-147517

Patent Document 2: Japanese Laid-open Patent Publication No. 6-54220

### SUMMARY

According to one aspect of embodiments, there is provided an information processing terminal that includes a search unit configured to search for identification information of a display apparatus capable of communicating via a network; a sending unit configured to send to the found display apparatus an identification information display request for displaying identification information of the display apparatus; an imaging unit configured to capture an image of the identification information displayed on a display unit of the display apparatus in response to the identification information display request; and an extraction unit configured to extract the identification information from the captured image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an apparatus control system of a first embodiment;

FIG. 2 is a diagram illustrating a hardware configuration example of an information processing terminal in the apparatus control system of the first embodiment;

FIG. 3 is a diagram illustrating functional configuration examples of the information processing terminal and a display apparatus in the apparatus control system of the first embodiment;

FIG. 4 is a sequence diagram illustrating an example of a procedure executed in the apparatus control system of the first embodiment;

FIG. 5 is a diagram illustrating an example of an apparatus search message;

FIG. 6 is a diagram illustrating an example of a response message;

FIG. 7 is a diagram illustrating a display example of apparatus identification information displayed on a display apparatus;

FIG. 8 is a diagram illustrating an example of the apparatus identification information an image of which is being captured by a digital camera of an information processing terminal;

FIG. 9 is a diagram illustrating an example of detailed information;

FIG. 10 is a diagram illustrating a synthesized example of the detailed information with a captured image;

FIG. 11 is a flowchart illustrating an example of a procedure executed by the information processing terminal in the apparatus control system of the first embodiment;

FIG. 12 is a diagram illustrating functional configuration examples of an information processing terminal and a display apparatus in an apparatus control system of a second embodiment;

FIG. 13 is a sequence diagram illustrating an example of a procedure executed in the apparatus control system of the second embodiment;

FIG. 14 is a flowchart illustrating an example of a procedure executed by the information processing terminal in the apparatus control system of the second embodiment; and

FIG. 15 is a diagram illustrating an example of a response message indicating that the display apparatus includes a display function to display the apparatus identification information.

### DESCRIPTION OF EMBODIMENTS

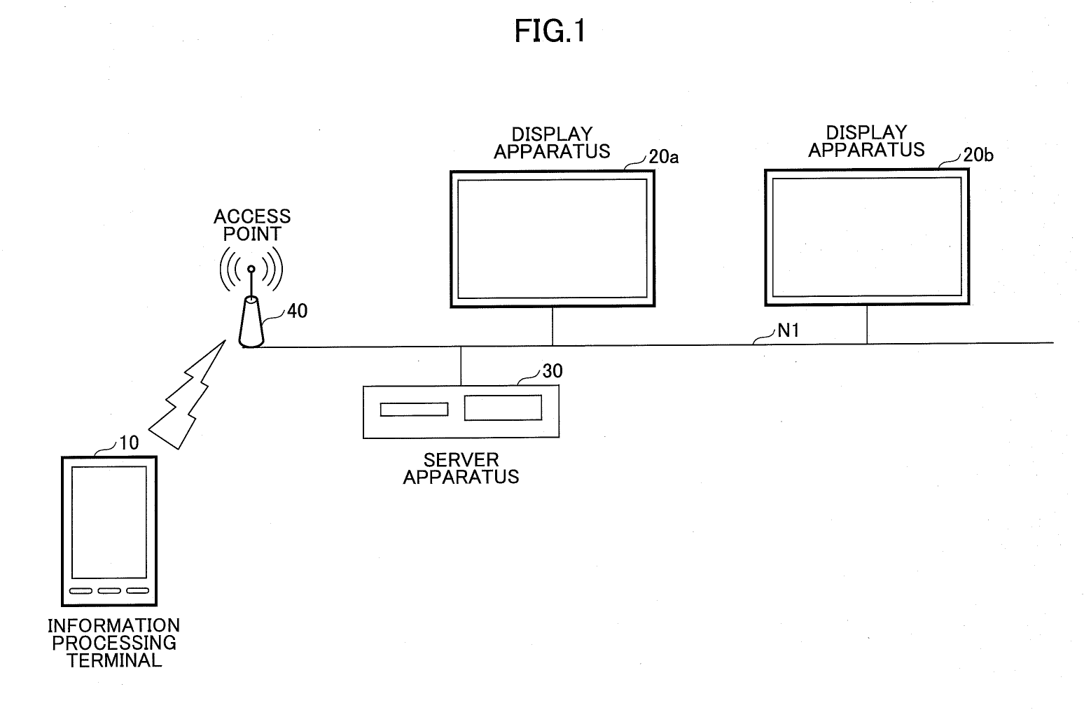

Preferred embodiments of the present invention will be described with reference to the accompanying drawings. FIG. 1 is a diagram illustrating a configuration example of an apparatus control system of a first embodiment. In an apparatus control system 1 illustrated in FIG. 1, an information processing terminal 10 is configured to communicate with electronic apparatuses such as a server apparatus 30, and display apparatuses 20a and 20b connected to a network N1 via an access point 40. The network N1 may be a wireless network such as a wireless local area network (LAN) or a wired network such as a wired LAN. Note that illustration of network apparatuses such as a router and the like, which are normally required for constructing the network, is omitted from FIG. 1 for convenience of illustration.

The server apparatus 30 serves as an electronic apparatus configured to store (save) static image data, dynamic image data, audio data, or other electronic data and the like. In the first embodiment, such electronic data may simply call “contents”. Examples of the server apparatus 30 include a network attached storage (NAS), a personal computer (PC), or the like.

The display apparatuses 20a and 20b serve as electronic apparatuses configured to display the contents saved by the server apparatus 30. The display apparatuses 20a and 20b may simply be referred to as a “display apparatus 20” or “display apparatuses 20” when the display apparatuses 20a and 20b are not distinguished from each other. An example of the display apparatus 20 includes a television, or the like.

The information processing terminal 10 serves as an electronic apparatus configured to perform control of each of the electronic apparatuses such as the server apparatus 30, and the display apparatuses 20a and 20b connected to the network N1 in response to an instruction input by a user. Examples of the information processing terminal 10 includes a smart phone, a tablet terminal, a mobile phone, a personal digital assistance (PDA), and a digital camera with a wireless LAN function, and the like.

In the first embodiment, the control of each of the electronic apparatuses is performed by the information processing terminal 10 by following procedures in compliance with the digital living network alliance (DLNA) guidelines. That is, the information processing terminal 10 serves as a digital media controller (DMC) in the DLNA guidelines. The display apparatus 20 serves as a digital media renderer (DMR). The server apparatus 30 serves as a digital media server (DMS).

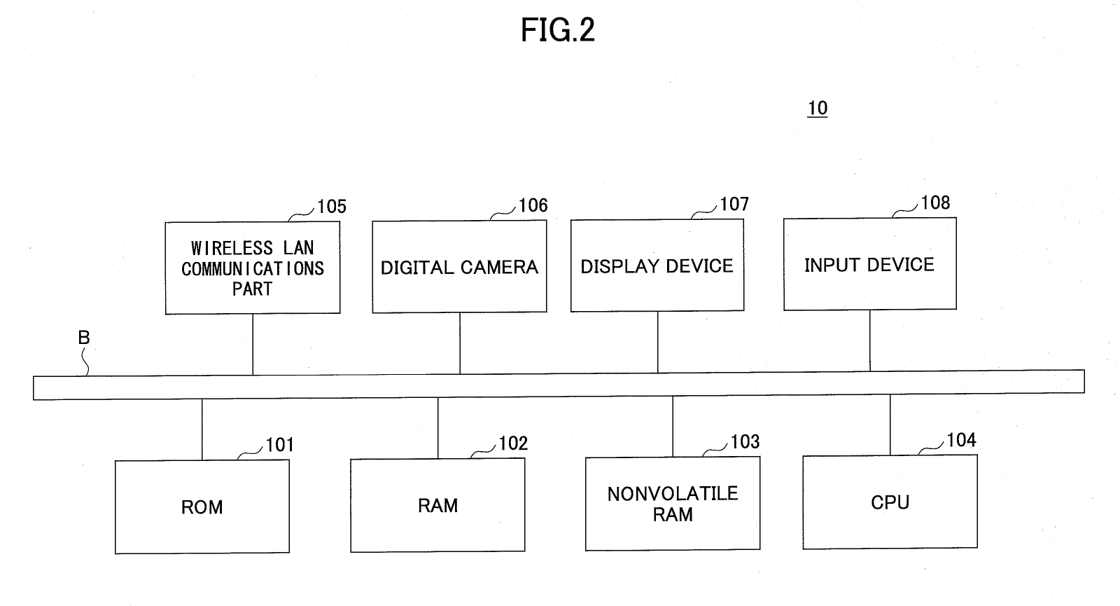

FIG. 2 is a diagram illustrating a hardware configuration example of an information processing terminal in the apparatus control system of the first embodiment. As illustrated in FIG. 2, the information processing terminal 10 includes a read-only memory (ROM) 101, a random-access memory (RAM) 102, a non-volatile RAM 103, a central processing unit (CPU) 104, a wireless LAN communications part 105, a digital camera 106, a display device 107, and an input device 108.

Programs for causing the information processing terminal 10 to execute processes are installed in the ROM 101 or the non-volatile RAM 103. For example, the above programs may be stored in the ROM 101 when the programs may need to be installed in advance before shipment of the information processing terminal 10. Note that the ROM 101 or the non-volatile RAM 103 may, in addition to the above programs, store various kinds of data utilized by the programs. The RAM 102 is configured to store a program and the like retrieved from the ROM 101 or the non-volatile RAM 103 when receiving an instruction to activate the program (i.e., an program activation instruction). The CPU 104 is configured to execute the later-described functions associated with the information processing terminal 10 in compliance with the program stored in the RAM 102. The wireless LAN communications part 105 may serve as hardware configured to perform wireless communications. The wireless LAN communications part 105 may, for example, include an antenna for performing the wireless communications. The digital camera 106 serves as hardware configured to capture an image of a subject. The display device 107 is configured to display various types of information output by the program. The input device 107 may be a touch-sensitive panel or buttons configured to receive an input instruction from the user.

Note that the display apparatus 20 may have a configuration similar to that of the information processing terminal illustrated in FIG. 2. However, shapes or performances of the hardware of the display apparatus 20 may differ from those of the hardware of the information processing terminal 10. Note also that the display apparatus 20 is not necessarily provided with the digital camera.

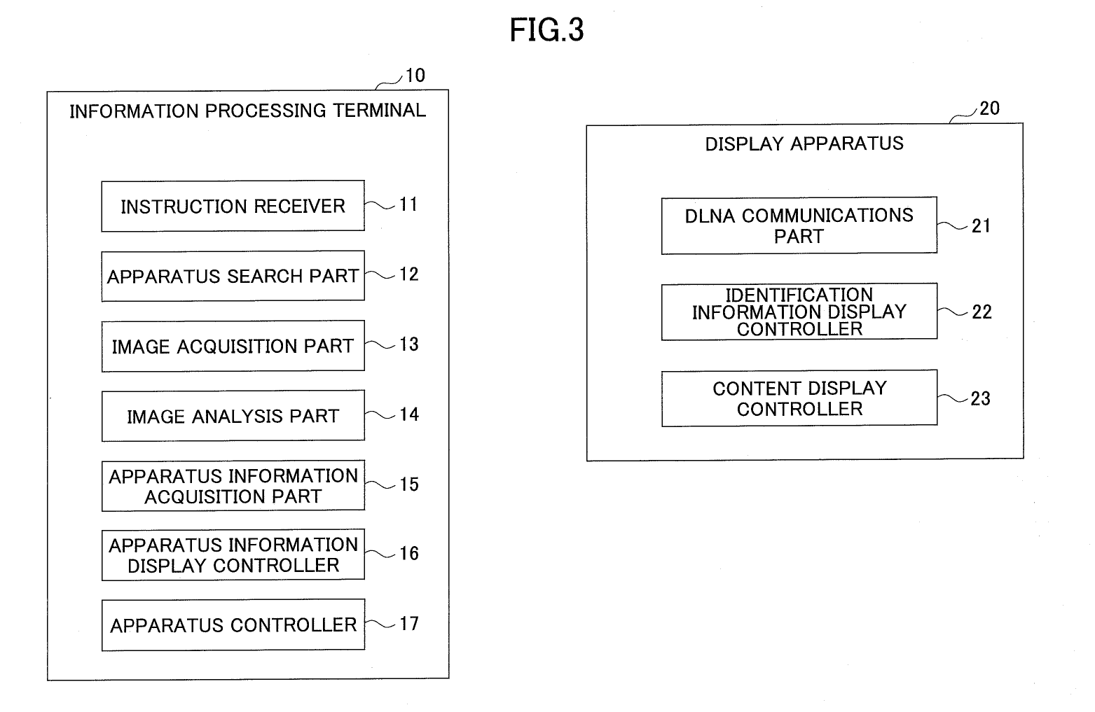

FIG. 3 is a diagram illustrating functional configuration examples of the information processing terminal 10 and a display apparatus 20 in the apparatus control system of the first embodiment. In FIG. 3, the display apparatus 20 includes a DLNA communications part 21, an identification information display controller 22, and a content display controller 23. These components may be implemented by causing a CPU 20 of the display apparatus 20 to execute one or more programs installed on the display apparatus 20.

The DLNA communications part 21 performs communications in compliance with the DLNA guidelines. The identification information display controller 22 causes a display unit (e.g., a liquid crystal display) of its own display apparatus 20 to display identification information of its own display apparatus 20 in response to transmission of a response to an apparatus search request in compliance with the DLNA guidelines. The identification information may be displayed in a form of a string of characters, or a two-dimensional code such as a QR code (Registered Trademark) and the like. The content display controller 23 performs content display control of the contents transferred from the server apparatus 30 by following a procedure in compliance with the DLNA guidelines.

On the other hand, the information processing terminal 10 includes an instruction receiver 11, an apparatus search part 12, an image acquisition part 13, an image analysis part 14, an apparatus information acquisition part 15, an apparatus information display controller 16, and an apparatus controller 17. The above components may be implemented by causing the CPU 104 to execute one or more programs installed on the information processing terminal 10.

The instruction receiver 11 is configured to receive an instruction from a user via an input device 108. The apparatus search part 12 is configured to search for electronic apparatuses capable of performing communications via a network N1 by sending apparatus search requests to the electronic apparatuses connected to the network N1 using the wireless LAN communications part 105. The image acquisition part 13 is configured to acquire an image (image data) captured by the digital camera 106. The image analysis part 14 is configured to analyze the image acquired by the image acquisition part 13. Specifically, the image analysis part 14 is configured to extract the identification information of the display apparatus 20 from the image acquired by the image acquisition part 13. In addition, the image analysis part 14 is configured to recognize a range (area) of the display apparatus 20 in the image acquired by the image acquisition part 13. That is, in the first embodiment, the identification information of the display apparatus 20 displayed by the display apparatus 20 may be captured by the digital camera 106.

The apparatus information acquisition part 15 is configured to acquire detailed attribute information (hereinafter referred to as “detailed information”) of the display apparatus in association with the identification information extracted by the image analysis part 14 using the wireless LAN communications part 105. The acquisition of the detailed information of the display apparatus 20 is executed by following a procedure in compliance with the DLNA guidelines. The apparatus controller 17 is configured to perform control of the electronic apparatuses such as the server apparatus 30 or the display apparatus 20 via the wireless LAN communications part 105 by following a procedure in compliance with the DLNA guidelines.

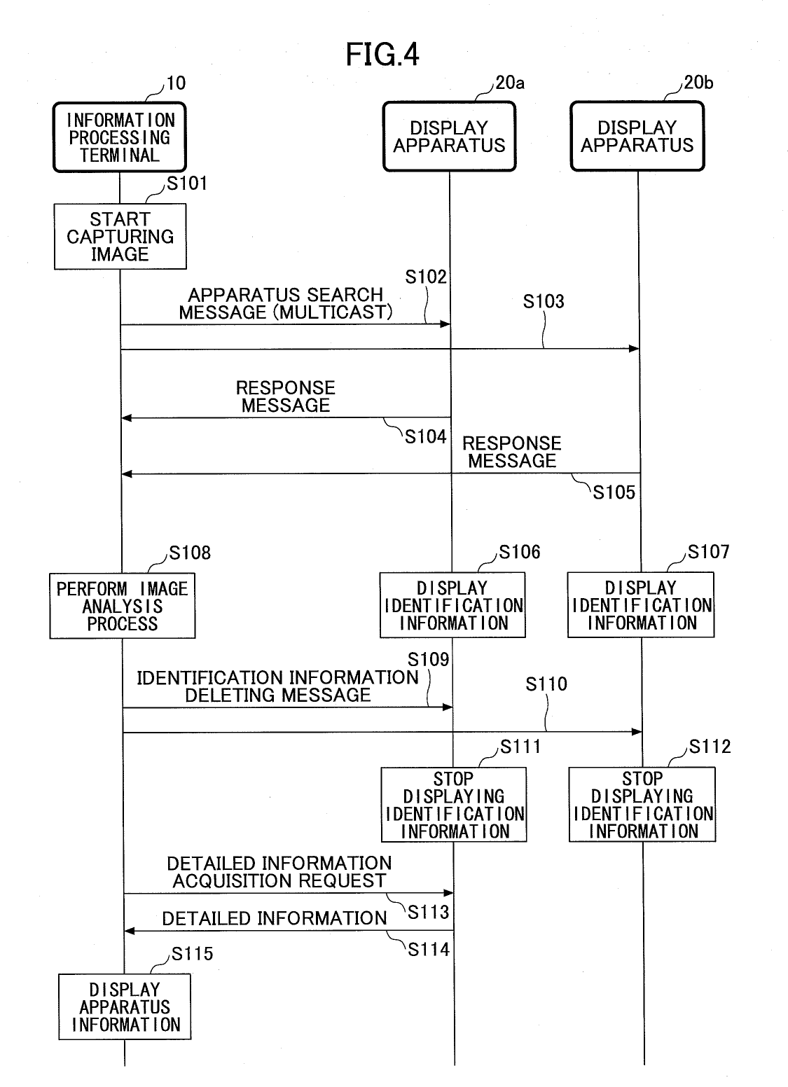

In the following, a description is given of a procedure executed in the apparatus control system 1 of the first embodiment. FIG. 4 is a sequence diagram illustrating an example of the procedure executed in the apparatus control system of the first embodiment.

In step S101, when the instruction receiver 11 receives an instruction from a user, the image acquisition part 13 activates the digital camera 106 to capture an image and displays the captured image on the display device 107, for example. The captured image is the image captured by the digital camera 106. Note that a shutter of the digital camera 106 is yet to be released at this stage. Hence, the captured image may change with a direction in which the digital camera 106 is pointed.

Subsequently, the apparatus search part 12 sends, either automatically or in response to the instruction input from the user, an apparatus search message to the network N1 using the wireless LAN communications part 105, and then awaits a response message to be transferred in return (steps S102, S103). The apparatus search message is a message indicating a request to search for an apparatus. The apparatus search message is transmitted via multicast communications in compliance with the DLNA guidelines.

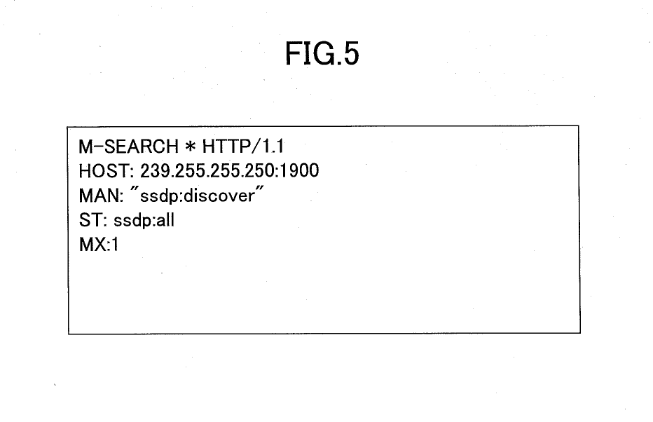

FIG. 5 is a diagram illustrating an example of the apparatus search message. Note that since the content of the apparatus search message is in compliance with the DLNA guidelines, detailed description of the content of the apparatus search message will be omitted from the specification.

The DLNA communications part 21 of the display apparatus 20 that has received the apparatus search message sends a response message to the information processing terminal 10 in return (steps S104, S105). Note that although the server apparatus 30 is not illustrated in FIG. 4, the server apparatus 30 is also an electronic apparatus in compliance with the DLNA guidelines, and hence, the server apparatus 30 is also configured to send a response message in return. The apparatus search part 12 of the information processing terminal 10 may, for example, store the received response message in the RAM 102.

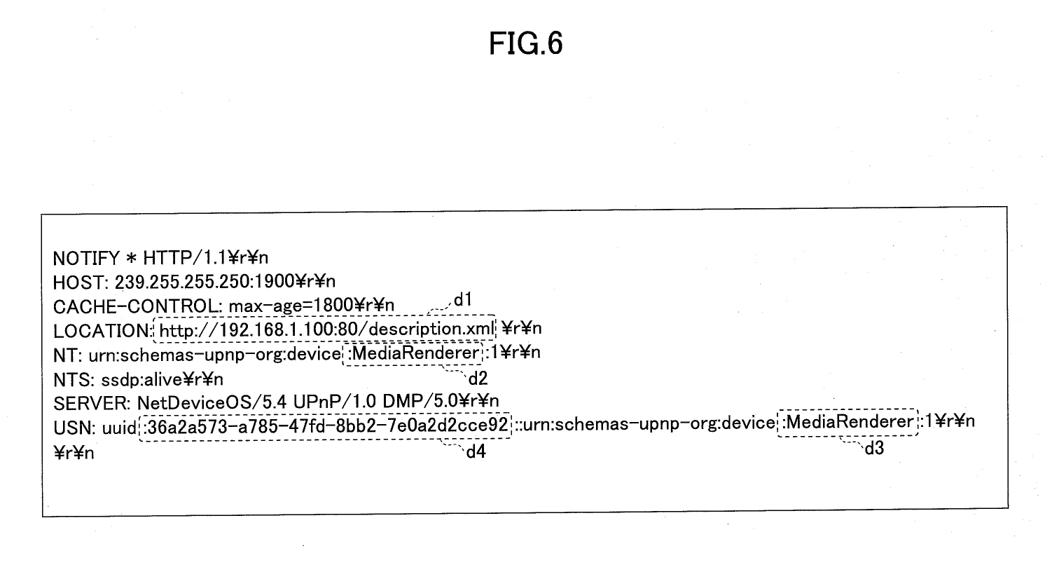

FIG. 6 is a diagram illustrating an example of the response message. In the response message illustrated in FIG. 6, a description d2 or a description d3 includes “MediaRenderer”, which indicates that an electronic apparatus serving as a source of the response message is a DMR. Further, a description d1 indicates a uniform resource locator (URL) corresponding to the detailed information of the electronic apparatus. A description d4 indicates a universally unique identifier (UUID) that uniquely identifies each of the electronic apparatuses. In the first embodiment, the UUID or a string of characters including the UUID may be an example of the identification information of the electronic apparatus. In the following descriptions, the UUID or the string of characters including “UUID” is called “apparatus identification information”. Note that the URL in a description d1 may be used as the “apparatus identification information”.

The identification information display controller 22 of the display apparatus 20 displays the apparatus identification information on the display part of the display apparatus 20 in response to the reception of the received apparatus search message or the transmission of the response message (steps S106 and S107).

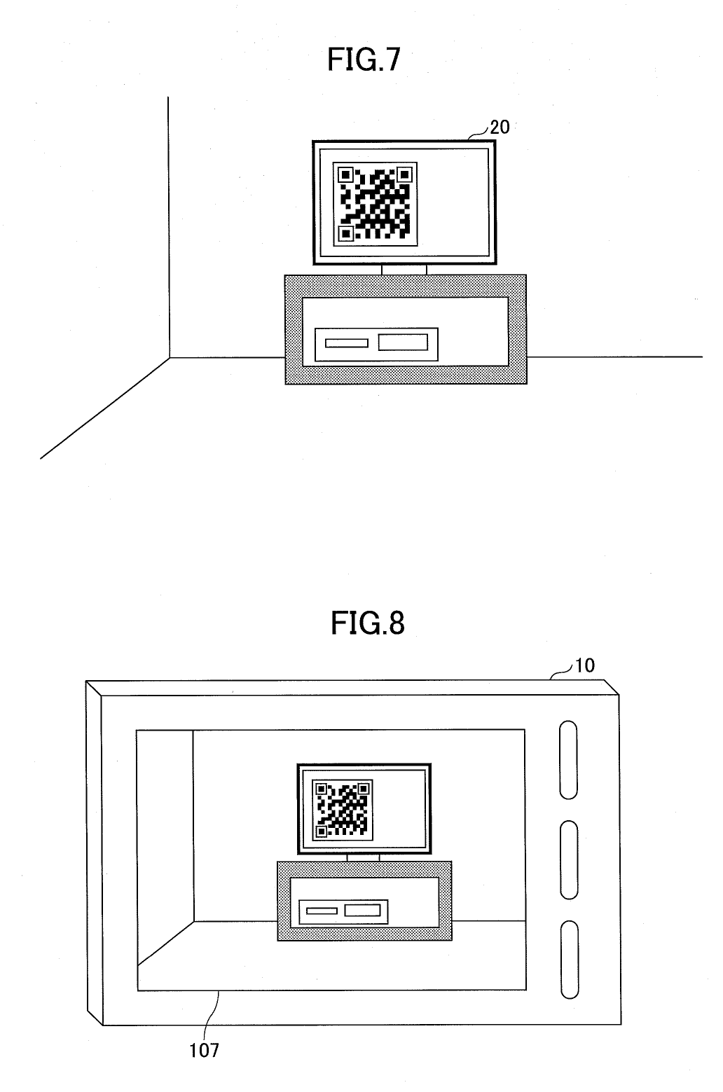

FIG. 7 is a diagram illustrating a display example of the apparatus identification information displayed on the display apparatus. Specifically, FIG. 7 illustrates an example of the apparatus identification information in the form of a QR code. Note that the apparatus identification information is not necessarily converted into and displayed as the two-dimensional code such as the QR code. The apparatus identification information may, for example, be displayed as it is in the form of a string of characters without being converted into any other forms. Alternatively, the apparatus identification information may be converted into and displayed as an image or a string of characters in other forms that may be translated by the information processing terminal 10.

The user uses the digital camera 106 of the information processing terminal 10 to capture an image of the apparatus identification information displayed on the display apparatus 20, which serves as a desired regenerating destination to regenerate the contents (a content regenerating destination).

FIG. 8 is a diagram illustrating an example of the apparatus identification information being captured by the digital camera of the information processing terminal. In the state illustrated in FIG. 8, a shutter of the digital camera is not necessarily released. That is, an image of the apparatus identification information displayed on the display apparatus 20 may be in a condition ready to be captured any time in the information processing terminal 10 via the digital camera 106.

Subsequently, the image analysis part 14 executes an analysis process of the captured image acquired by the image acquisition part 13 (step S108). Specifically, the image analysis part 14 extracts a string of characters of the apparatus identification information from the captured image. When the apparatus identification information is displayed as a string of characters, an optical character recognition (OCR) technology or the like may be used in order to extract the string of characters of the apparatus identification information from the captured image. In addition, when the apparatus identification information is displayed in a two-dimensional code, a two-dimensional code analysis technology may be used. In the following descriptions, the “apparatus identification information” indicates a string of characters illustrating the apparatus identification information. Further, the image analysis part 14 may, for example, specify an area or a range of the display apparatus 20 on the captured image by recognizing a rectangular shape or the like that encloses the apparatus identification information. The area of the display apparatus 20 may need to be specified in order to detect that the user has touched the display apparatus 20 in a touch operation performed by the user in a later stage.

Subsequently, the apparatus controller 17 sends an identification information deleting message to each of the display apparatuses 20 via the wireless LAN communications part 105 (steps S109 and S110). The identification information display controller 22 of the display apparatus 20 stops displaying the apparatus identification information in response to the reception of the identification information deleting message (steps S111 and S112). Note that the display apparatus 20 may be configured such that the display apparatus 20 automatically stops displaying the apparatus identification information when a predetermined period has elapsed from a display starting time at which the apparatus identification information starts being displayed on the display apparatus 20. In this case, the apparatus controller 17 does not need to transmit an identification information deleting message.

Subsequently, the apparatus information acquisition part 15 searches for a response message including a universally unique identifier (UUID) contained in the apparatus identification information extracted from the captured image from the response messages stored in the RAM 102. The apparatus information acquisition part 15 transmits a detailed information acquisition request to an URL address contained in the description d1 of the corresponding response message via the wireless LAN communications part 105 by following a procedure in compliance with the DLNA guidelines. That is, the detailed information acquisition request is transmitted to the display apparatus 20 the image of which is captured by the digital camera 106. In FIG. 4, it is assumed that an image of the display apparatus 20a is captured. Hence, the detailed information acquisition request is transmitted to the display apparatus 20a.

The DLNA communications part 21 of the display apparatus 20a that has received the detailed information acquisition request sends detailed information of the own display apparatus 20a to the information processing terminal 10 in return by following a procedure in compliance with the DLNA guidelines (step S114).

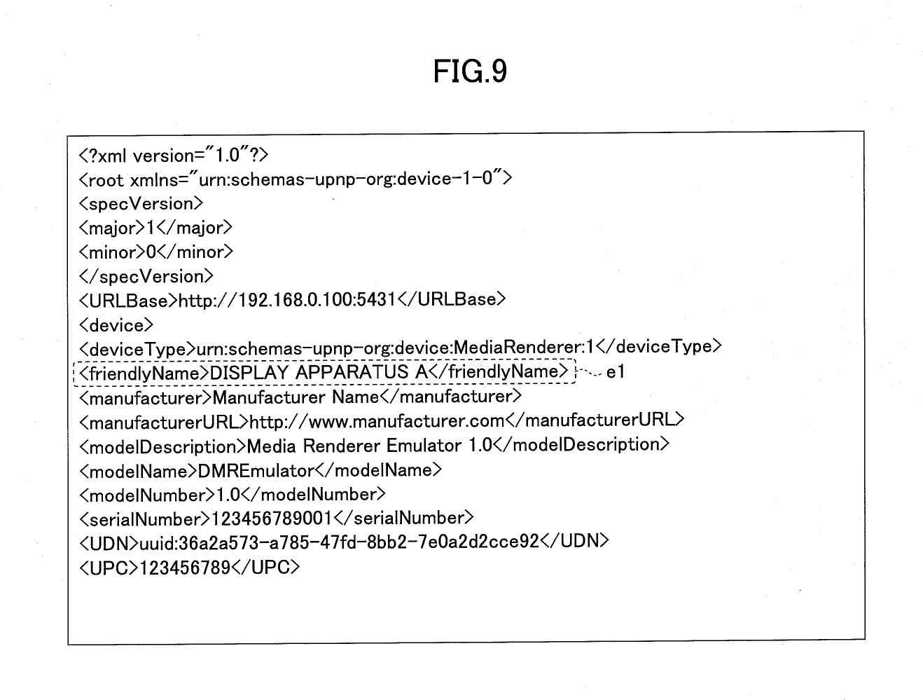

FIG. 9 is a diagram illustrating an example of the detailed information. A configuration of the detailed information is in compliance with the DLNA guidelines, and hence illustration of the detailed information will be omitted from the specification.

Subsequently, the apparatus information display controller 16 synthesizes a part of the acquired detailed information with the captured image and displays the synthesized image on the display device 107 (step S115). An element subject to the synthesis and the display may, for example, be a value (“DISPLAY APPARATUS A”) of a “friendlyName” element e1 illustrated in FIG. 9. This is because the value of the friendlyName element e1 is a relatively easy name for the user to understand. However, the value of the friendlyName element e1 is not necessarily unique to each of the electronic apparatuses. Note that other information contained in the detailed information may be synthesized with the captured image.

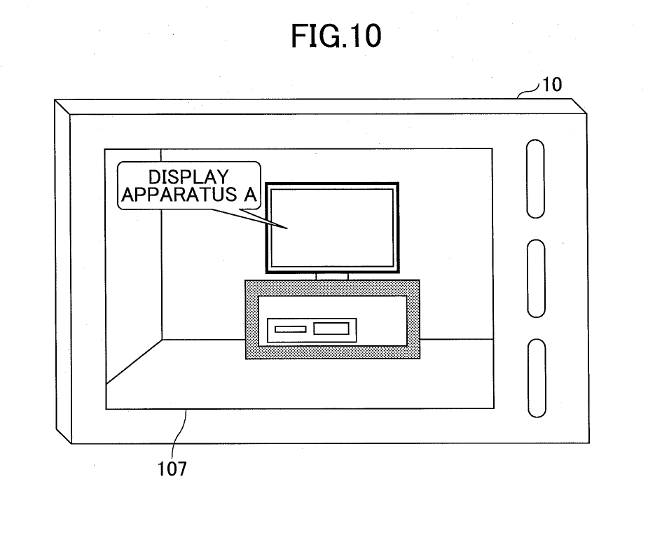

FIG. 10 is a diagram illustrating a synthesized example of the detailed information with the captured image. FIG. 10 illustrates an example in which the value of the friendlyName element e1 is synthesized with the captured image. Hence, the user may easily acknowledge an identification name of the display apparatus 20 that may serve as a desirable content regenerating destination by browsing a screen of the information processing terminal 10 illustrated in FIG. 10.

Note that a shutter of the digital camera 106 of the information processing terminal 10 is yet to be released in the state illustrated in FIG. 10.

Thereafter, when the user touches the captured image of the display apparatus 20 displayed on the display device 107, the apparatus controller 17 may send a content display request or the like stored in the server apparatus 30 to the display apparatus 20 associated with the apparatus identification information extracted by the image analysis part 14 by following a procedure in compliance with the DLNA guidelines. Alternatively, the content display request may automatically be transmitted to the display apparatus 20 in response to the extraction of the apparatus identification information from the captured image without waiting for the user to touch the screen of the display device 107 to select the captured image of the display apparatus 20 on the display device 107. In this case, the user may be provided with operability to automatically initiating regeneration of the apparatus identification information, which may be triggered by causing the digital camera 106 to capture an image of the display apparatus 20 that displays the apparatus identification information. That is, the apparatus controller 17 (a sending unit) may send the content display request (a data display request) for displaying data (contents) stored in the server apparatus 30 (a storage apparatus) capable of communicating via the network to the display apparatus 20 in association with the identification information extracted by the image analysis part 14 (an extraction unit).

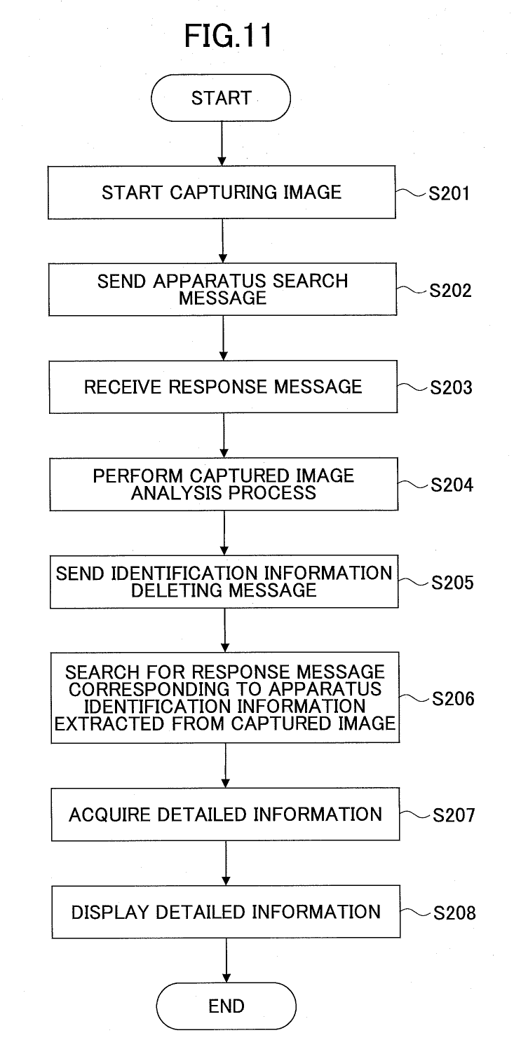

Next, a description will be given below of a procedure executed by the information processing terminal 10 in FIG. 4. FIG. 11 is a flowchart illustrating an example of the procedure executed by the information processing terminal 10 in the first embodiment. Respective steps in FIG. 11 are similar to those described with reference to FIG. 4. Thus, the description of the steps in FIG. 11 may appropriately be simplified.

In step S201, the image acquisition part 13 activates the digital camera 106 to capture an image and displays the captured image on the display device 107. Subsequently, the apparatus search part 12 sends an apparatus search message (step S202). Subsequently, the apparatus search part 12 receives a response message in response to the apparatus search message, and stores the received response message in the RAM 102 (step S203).

At this stage, the apparatus identification information is displayed corresponding to each of the display apparatuses 20. Further, an image of the display apparatus 20 subject to control desired by the user is captured by the digital camera 106.

Subsequently, the image analysis part 14 executes an analysis process of the captured image acquired by the image acquisition part 13 (step S204). As a result, apparatus identification information is extracted from the captured image. In addition, a range (area) of the display apparatus 20 is specified in the captured image acquired by the image acquisition part 13.

Subsequently, the apparatus controller 17 sends an identification information deleting message to each of the display apparatuses 20 (step S205). Then, the apparatus information acquisition part 15 searches for a response message including a universally unique identifier (UUID) contained in the apparatus identification information extracted from the captured image from the response messages stored in the RAM 102 (step S206).

Subsequently, the apparatus information acquisition part 15 acquires detailed information by sending a detailed information acquisition request to a URL address of the detailed information contained in the corresponding response message (step S207). Then, the apparatus information display controller 16 synthesizes a part of the acquired detailed information with the captured image and displays the synthesized image on the display device 107 (step S208).

As described above, the information processing terminal 10 in the first embodiment may be able to specify an electronic apparatus subject to control desired by the user based on the apparatus identification information extracted from the captured image. Hence, the user may capture an image of the display apparatus 20 by using the digital camera 106 so as to acquire information about the display apparatus 20 subject to control or specify the display apparatus 20 subject to control. As a result, a specifying process to specify the electronic apparatus subject to control via the network may be simplified.

That is, a user interface utilizing Augmented Reality (AR) may be provided by synthesizing the detailed information of the display apparatus 20 with the captured image and displaying the synthesized image. Consequently, the user may be able to specify a desired display apparatus 20 subject to control by directly selecting the displayed image of the display apparatus 20.

Next, an information processing terminal in an apparatus control system of a second embodiment will be described. In the following description of the second embodiment, parts of the second embodiment differing from those of the first embodiment will mainly be described. Hence, those of the second embodiment not specifically referred to in the following description may be similar to those of the first embodiment.

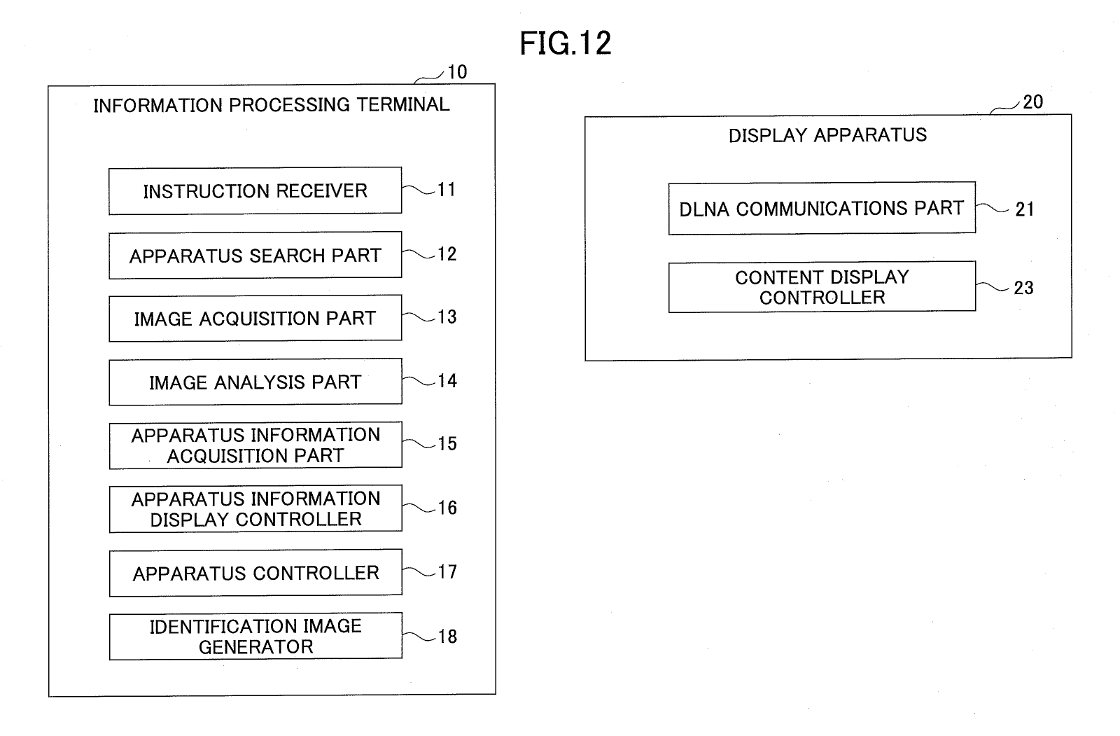

FIG. 12 is a diagram illustrating functional configuration examples of the information processing terminal and a display apparatus in the apparatus control system of the second embodiment. Therefore, those elements of the second embodiment illustrated in FIG. 12 that are the same as or equivalent to those of the first embodiment illustrated in FIG. 3 are designated by the same reference numerals, and a description thereof will be omitted.

In FIG. 12, the information processing terminal 10 further includes an identification image generator 18. The identification image generator 18 is configured to generate image data including the apparatus identification information.

On the other hand, the display apparatus 20 in the second embodiment does not include the identification information display controller 22.

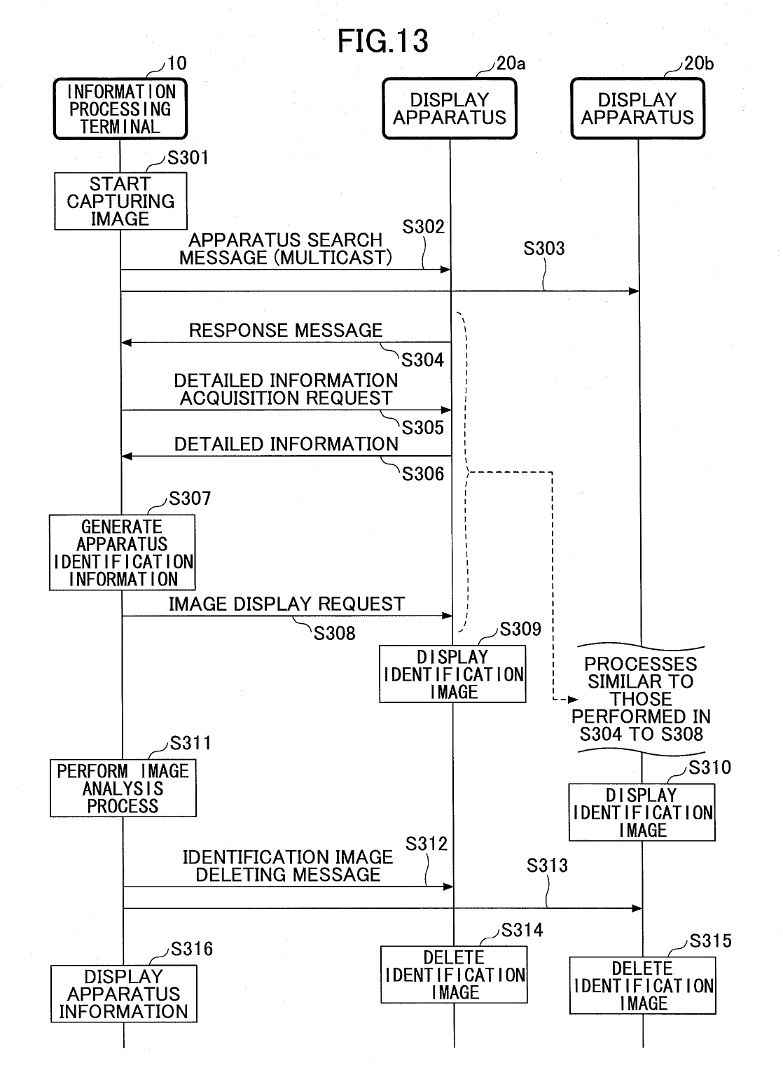

In the following, a description is given of a procedure executed in the apparatus control system 1 of the second embodiment. FIG. 13 is a sequence diagram illustrating an example of the procedure executed in the apparatus control system of the second embodiment.

Steps S301 to and S304 in FIG. 13 may be similar to steps S104 to S101 in FIG. 4.

In step S305, the apparatus information acquisition part 15 of the information processing terminal 10 sends, in response to a response message from the display apparatus 20a, a detailed information acquisition request to a URL address of the detailed information contained in the corresponding response message. The detailed information acquisition request may be transmitted using the wireless LAN communications part 105 by following the procedure in compliance with the DLNA guidelines. The DLNA communications part 21 of the display apparatus 20a that has received the detailed information acquisition request sends detailed information of the own display apparatus 20a to the information processing terminal 10 in return by following a procedure in compliance with the DLNA guidelines (step S306). The apparatus information acquisition part 15 may, for example, store the received detailed information in the RAM 102.

Subsequently, the identification image generator 18 of the information processing terminal 10 generates image data having the embedded apparatus identification information including the UUID contained in the transmitted detailed information or the response message (step S307). The image data may hereinafter be called “identification image”. The identification image may contain the apparatus identification information that is in the form of a string of characters or in the form of a two dimensional code. Alternatively, the apparatus identification information may be converted into and displayed as an image or a string of characters in other forms that may be translated by the information processing terminal 10.

Subsequently, the apparatus controller 17 of the information processing terminal 10 sends an identification image together with an identification image display request to the display apparatus 20a using the wireless LAN communications part 105 by following the procedure in compliance with the

DLNA guidelines (step S308). In the display apparatus 20a, when the DLNA communications part 21 receives the identification image display request, the content display controller 23 displays the identification image on the display part of the display apparatus 20a (step S309). That is, the transmission of the identification image may be executed as transmission of the content in compliance with the DLNA guidelines. Accordingly, the display of the identification image may be executed by the content display controller 23 configured to display the contents by following a procedure in compliance with the DLNA guidelines. Hence, each of the display apparatuses 20 in the second embodiment does not need to include the identification information display controller 22. That is, in the second embodiment, each of the display apparatuses 20 does not need to have a function uniquely tailored to the second embodiment (i.e., the identification information display controller 22) insofar as the display apparatuses 20 are in compliance with the DLNA guidelines.

Note that processes similar to those in steps S304 to 308 are also executed in the display apparatus 20b. As a result, the content display controller 23 of the display apparatus 20b displays the identification image including the identification information of the own display apparatus 20b on the display part of the display apparatus 20b (step S310).

Steps subsequent to step S311 in FIG. 13 may be similar to the steps subsequent to step S108 illustrated in FIG. 4. Note that since the detailed information is already acquired, processes corresponding to steps S113 and 114 will not be executed. In addition, the transmission of an identification image deleting message in steps S312 and S313 may be transmitted as a content display deactivation request in compliance with the DLNA guidelines. As a result, the content display controller 23 of each of the display apparatuses 20 stops displaying the identification image by following a procedure in compliance with the DLNA guidelines (steps S314 and S315).

Note that a timing at which the information processing terminal 10 acquires the detailed information may be similar to the timing described in the first embodiment. That is, the detailed information is not necessarily acquired before the generation of the identification image. This is because the UUID is contained in the response message in response to the apparatus search message.

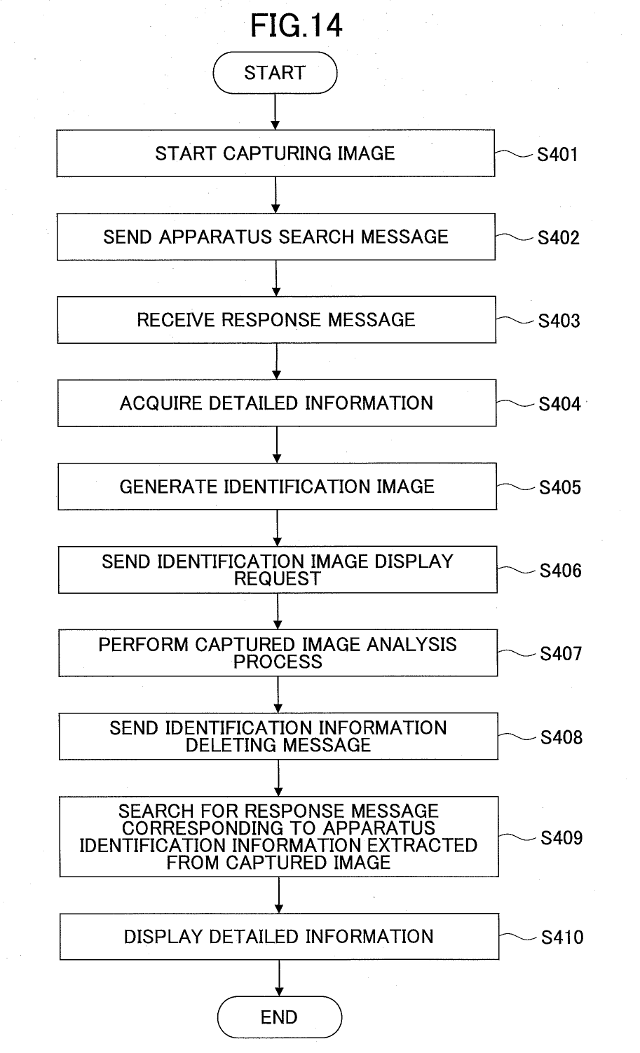

Next, a description will be given below of a procedure executed by the information processing terminal 10 in FIG. 13. FIG. 14 is a flowchart illustrating an example of the procedure executed by the information processing terminal 10 in the second embodiment. Respective steps in FIG. 14 are similar to those described with reference to FIG. 13. Thus, the description of the steps in FIG. 14 may appropriately be simplified.

Steps S401 to and S403 in FIG. 14 may be similar to steps S201 to S203 in FIG. 11.

Subsequently, the apparatus information acquisition part 15 acquires detailed information of the display apparatus 20 serving as a returning destination of the response message by sending the detailed information acquisition request to a URL address of the detailed information contained in the response message (step S404). Subsequently, the identification image generator 18 generates an identification image corresponding to the display apparatus 20 (step S405). Then, the apparatus controller 17 sends the identification image to the display apparatus 20 (step S406). As a result, the identification image is displayed on (the display part of) the display apparatus 20. Note that steps S403 to 406 are executed in each of the display apparatuses 20.

Steps subsequent to step S407 may be similar to the steps subsequent to step S204 illustrated in FIG. 11. Note that a process corresponding to step S207 may be unnecessary.

As described above, the second embodiment may provide an effect similar to that obtained in the first embodiment. In addition, the second embodiment may simplify the implementation of the display apparatus 20.

Note that the first embodiment and the second embodiment are not mutually selective or exclusive, and therefore the first and the second embodiments may be implemented simultaneously.

Specifically, the information processing terminal 10 may apply the procedure in the first embodiment to the display apparatus 20 having a display function to display the apparatus identification information, whereas the information processing terminal 10 may apply the procedure in the second embodiment to the display apparatus 20 not having the display function to display the apparatus identification information. Whether the display apparatus 20 includes the display function to display the apparatus identification information may be determined based on whether the display apparatus 20 includes the identification information display controller 22.

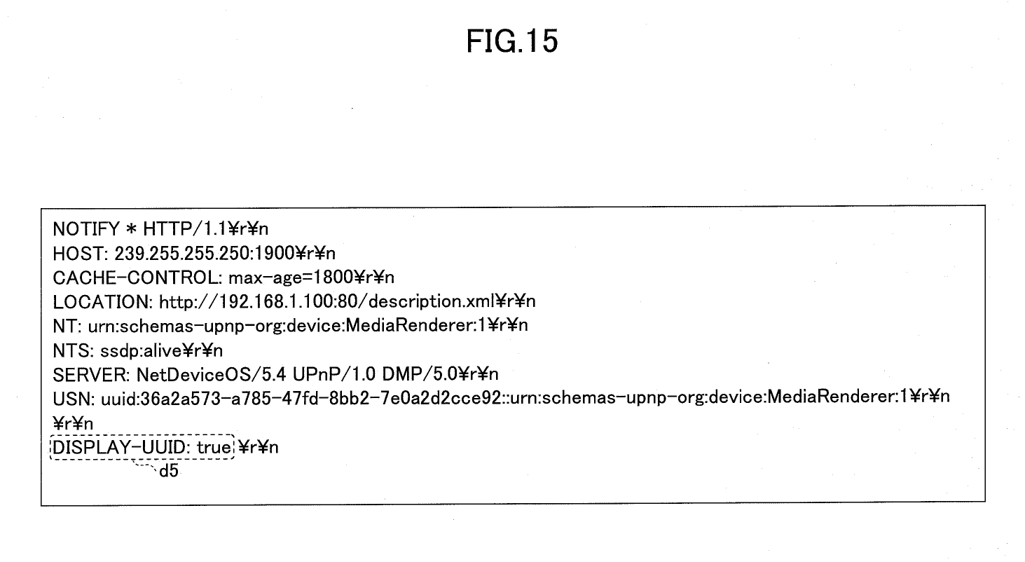

Hence, it may be necessary for the information processing terminal 10 to identify whether each of the display apparatuses 20 includes the identification information display controller 22. Accordingly, the display apparatus 20 having the identification information display controller 22 may, for example, send a response message in return illustrated in FIG. 15 in response to the apparatus search message.

FIG. 15 is a diagram illustrating an example of a response message indicating that the display apparatus includes a display function to display the apparatus identification information.

In the response message illustrated in FIG. 15, a description d5 stating “DISPLAY-UUID: true” indicates that the display apparatus 20 includes a display function to display the apparatus identification information.

Hence, the information processing terminal 10 may be configured to send the apparatus identification information display request to the display apparatus 20 to which the information processing terminal 10 has sent the response message containing the description d5, whereas the information processing terminal 10 may be configured to send the identification image to the display apparatus 20 to which the information processing terminal 10 has sent the response message not containing the description d5.

Note also that in each of the first and the second embodiments, the technology enabling the interconnection of the electronic apparatuses is illustrated by giving the examples in compliance with the DLNA guidelines. However, the first and the second embodiments may also be applied to specifications or standards of interconnection of the electronic apparatuses that are not in compliance with the DLNA guidelines.

Further, in each of the first and the second embodiments, the apparatus search part 12 may be an example of a search unit. The apparatus controller 17 may be an example of a sending unit. The display device 106 may be an example of an imaging unit. The image analysis part 14 may be an example of an extraction unit. The identification image generator 18 may be an example of a generator. The apparatus information acquisition part 15 may be an example of an acquisition unit. The server apparatus 30 may be an example of a storage apparatus.

According to one aspect of the embodiments, to specify the electronic apparatus subject to control via the network may be simplified.

Although the embodiments are numbered with, for example, “first”, or “second”, these numbers do not specify priorities of the embodiments. Numerous other variations and modifications will be made, which is apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing terminal, comprising:
a search unit configured to search for identification information of a display apparatus capable of communicating via a network;
a sending unit configured to send to the found display apparatus an identification information display request for displaying identification information of the display apparatus;
an imaging unit configured to capture an image of the identification information displayed on a display unit of the display apparatus in response to the identification information display request; and
an extraction unit configured to extract the identification information from the captured image.

2. The image processing terminal as claimed in claim 1, further comprising:
a generator configured to generate image data containing the identification information, wherein
the sending unit sends an image data display request for displaying the generated image data.

3. The image processing terminal as claimed in claim 1, further comprising:
an acquisition unit configured to acquire, from the display apparatus in association with the identification information extracted by the extraction unit, attribute information of the display apparatus; and
a display controller configured to synthesize the acquired attribute information with the captured image captured by the imaging unit to display the synthesized image on the information processing terminal.

4. The image processing terminal as claimed in claim 1, wherein the sending unit sends a data display request for displaying data stored in a storage apparatus capable of communicating via the network to the display apparatus in association with the identification information extracted by the extraction unit.

5. An information processing method executed by an information processing terminal, the information processing method, comprising:
searching for identification information of a display apparatus capable of communicating via a network;
sending to the found display apparatus an identification information display request for displaying identification information of the display apparatus;
capturing an image of the identification information displayed on a display unit of the display apparatus in response to the identification information display request; and
extracting the identification information from the captured image.

6. The information processing method as claimed in claim 5, further comprising:
generating image data containing the identification information, wherein
the sending includes sending an image data display request for displaying the generated image data.

7. The information processing method as claimed in claim 5, further comprising:
acquiring, from the display apparatus in association with the extracted identification information, attribute information of the display apparatus; and
synthesizing the acquired attribute information with the captured image to display the synthesized image on the information processing terminal.

8. The information processing method as claimed in claim 5, further comprising:
sending a data display request for displaying data stored in a storage apparatus capable of communicating via the network to the display apparatus associated with the extracted identification information.

9. An apparatus control system including an information processing terminal, and a display apparatus capable of communicating with the information processing terminal via a network, the apparatus control system comprising:
a search unit configured to search for identification information of the found display apparatus capable of communicating via the network;
a sending unit configured to send to the display apparatus an identification information display request for displaying identification information of the display apparatus;
an imaging unit configured to capture an image of the identification information displayed on a display unit of the display apparatus in response to the identification information display request; and
an extraction unit configured to extract the identification information from the captured image.

10. The apparatus control system as claimed in claim 9, wherein
the information processing terminal includes
a generator configured to generate image data containing
the identification information, wherein the sending unit sends an image data display request for displaying the generated image data.

11. The apparatus control system as claimed in claim 9, wherein
the information processing terminal includes
an acquisition unit configured to acquire, from the display apparatus in association with the identification information extracted by the extraction unit, attribute information of the display apparatus; and
a display controller configured to synthesize the acquired attribute information with the captured image captured by the imaging unit to display the synthesized image on the information processing terminal.

12. The apparatus control system as claimed in claim 9, wherein the sending unit sends a data display request for displaying data stored in a storage apparatus capable of communicating via the network to the display apparatus in association with the identification information extracted by the extraction unit.
